(19) United States
(12) Patent Application Publication
(10) Pub. No.: US 2009/0120843 A1
(43) Pub. Date: May 14, 2009

(54) Filtration Apparatus and Method

(75) Inventors: Ashok Gidwani, Huntsville, AL (US); Debasis Sengupta, Annandale, NJ (US); Vernon Cole, Huntsville, AL (US); Stelu Deaconu, Huntsville, AL (US); Jianjun Wei, Madison, AL (US)

Correspondence Address: TOMAS FRIEND, LLC, 904 BOB WALLACE AVENUE, SUITE 228, HUNTSVILLE, AL, 35801, US

(73) Assignee: CFD Research Corporation, Huntsville, AL (US)

(21) Appl. No.: 11/930,819

(22) Filed: Oct. 31, 2007

(51) Int. Cl. C10G 25/00; B01J 8/02

(52) U.S. Cl. 208/251 R; 422/239

(57) ABSTRACT

A filtration apparatus is disclosed for the removal of metals from jet fuel at high flow rates and limited pressure drops. The filter comprises a monolayer of immobilized chelating agent on packed silica gel. The filtration apparatus is particularly useful for the removal of copper from jet fuel.

### STATEMENT REGARDING FEDERALLY SPONSORED RESEARCH OR DEVELOPMENT

The U.S. Government has rights in the invention pursuant to contract N68335-06-C-0241 awarded by the United States Navy.

### CROSS-REFERENCE TO RELATED APPLICATIONS

Not Applicable

### INCORPORATED-BY-REFERENCE OF MATERIAL SUBMITTED ON A COMPACT DISC

Not Applicable

### BACKGROUND OF THE INVENTION

1. Field of the Invention

The present invention relates to the rapid removal of dissolved contaminants from large volumes of liquid. In particular, the invention is an apparatus and associated method for high flow rate, low pressure drop removal of metals from fuels.

2. Description of Related Art

Trace amounts of metals such as copper, zinc, iron, and lead in hydrocarbon fuels can cause undesirable oxidative degradation and reduced thermal stability of the fuels and, in some cases, can damage aircraft engines, reducing their working life. Consequently apparatus and methods for removing metals from fuels are needed.

Materials useful for the removal of dissolved metals from liquids such as water and hydrocarbon fuels are known in the art. U.S. Pat. No. 6,077,421 discloses metal chelating molecules linked to a solid substrate for the removal of a metal ion from a liquid. U.S. Pat. No. 6,297,191 discloses a composition for removing metals from jet fuel comprising a solid substrate linked to an organic macrocycle or polyol metal chelant. U.S. Pat. No. 6,248,842 discloses synthetic polymer matrices having selective chelation sites.

The use of chelating agents to remove metals such as copper from hydrocarbon fuels is known in the art. Puranik et al. (1998) Energy and Fuels 12:792-797 discloses the removal of copper from fuel by chelating agents linked to a solid support. Specifically, this reference discloses the use of 70-230 mesh silica modified with DETA 1,4,8-11-tetraazacyclotetradecane (cyclam) or N¹-[3-(trimethoxysilyl)propyl]diethylenetriamine (DETA) for the removal of copper from jet fuel.

While agents capable of removing copper and other metal contaminants from petroleum fuels are known, the removal of contaminants from fuels has not thus far been possible in practice. For the known agents to be of practical utility, methods and apparatus are needed that will allow the efficient removal of metal contaminants from fuels at flow rates of tens and hundreds of gallons per minute. Thus far, attempts to increase the scale of fuel decontamination from small volumes (<1 liter) at low flow rates (<100 ml per minute) to practical flow rates and pressure drops has not been achieved (Puranik 1998). The present invention overcomes the existing limitations of scale to fill the need for an apparatus and method capable of removing metal contaminants from hydrocarbon fuels at useful flow rates and pressure drops.

### BRIEF SUMMARY OF THE INVENTION

The present invention provides for the removal of copper and other contaminating metals from hydrocarbon fuels at useful flow rates and with relatively low pressure drops. The apparatus and method of the present invention balance pressure drops, residence times, flow rates, flow distribution, reactor bed particle sizes, and chelating efficiency to decontaminate fuels at useful flow rates and pressure drops.

### BRIEF DESCRIPTION OF THE SEVERAL VIEWS OF THE DRAWINGS

FIGS. 1 A and B is a graph showing the calculated dependency of copper concentration and pressure drop on solid support bead size for different flow rates for an apparatus according to the present invention.

FIG. 2 is a graph showing the calculated dependency of copper concentration and pressure drop on solid support bead size for different flow rates for an apparatus according to the present invention.

FIG. 3 is a table showing representative design parameters for a pancake bed apparatus according to the present invention.

FIGS. 4 A and B are side and cross-sectional views of a fuel purification decontamination apparatus having a convex disc-shaped separation chamber.

FIGS. 5 A and B are side and cross-section views of a fuel purification decontamination apparatus having a cylindrical-shaped separation chamber.

FIG. 6 is a table showing representative design parameters for an annular reactor bed apparatus according to the present invention.

### DETAILED DESCRIPTION OF THE INVENTION

The example of removing of copper from jet fuel is described in detail to provide written description of the invention but is not in any way intended to limit the scope of the invention to any contaminant, fuel, or chelant.

Scaling up laboratory scale processes for removing metal contaminants from fuels to commercial aid industrial scales is a technical challenge and requires simultaneous balancing of flow patterns, pressure drops, binding kinetics and transport, and depth and size distribution of solid supports for chelants.

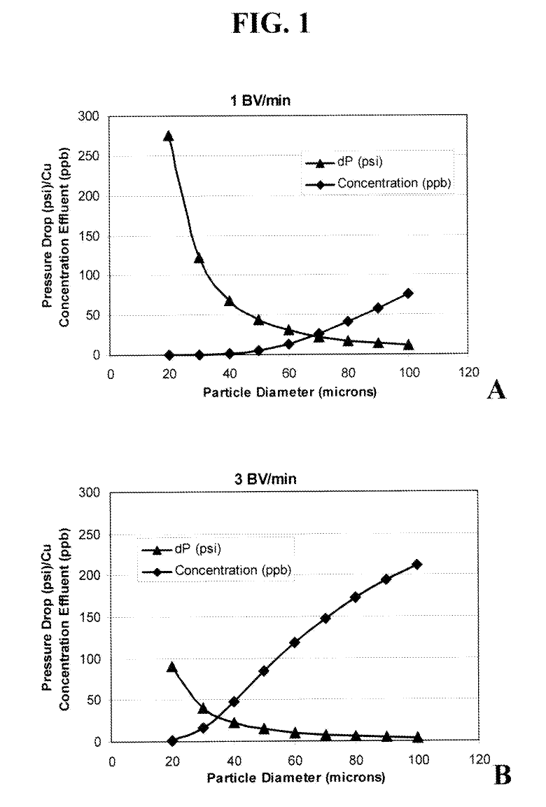

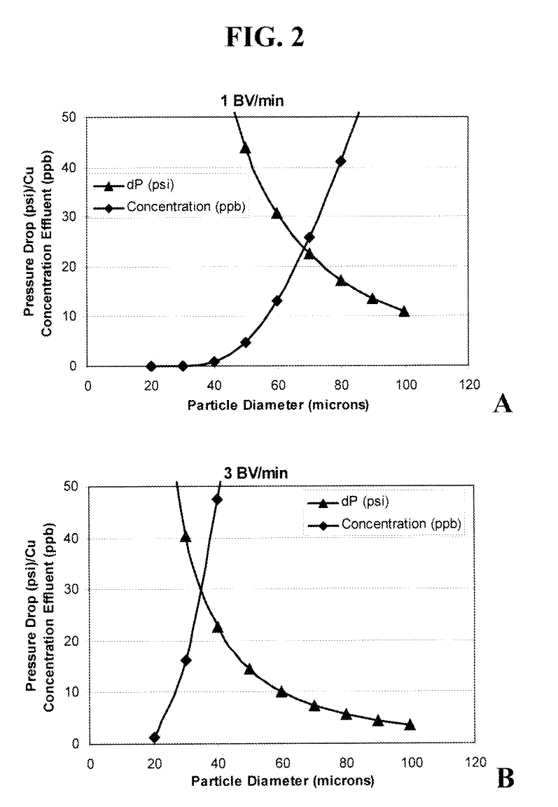

Theoretical analysis and multiphysics CFD simulations (CFD)-ACE+®. ESI Group) of fluid flow and chemical reactions were performed as functions of multiple variables including reactor volume, aspect ratio, flow rates, solid support particle sizes, and chemical chelant. Configurations were identified that maximize contaminant removal and minimize pressure drop at desired flow rates. Small and intermediate scale laboratory tests confirmed results of the simulations. Scaling (sizing) analysis calculations based on the simulations and experiments are shown in FIGS. 1 A and B and FIGS. 2 A and B. The information in these graphs corresponds to an initial copper concentration of 350 ppb and a disc-shaped reactor bed 120 mm thick.

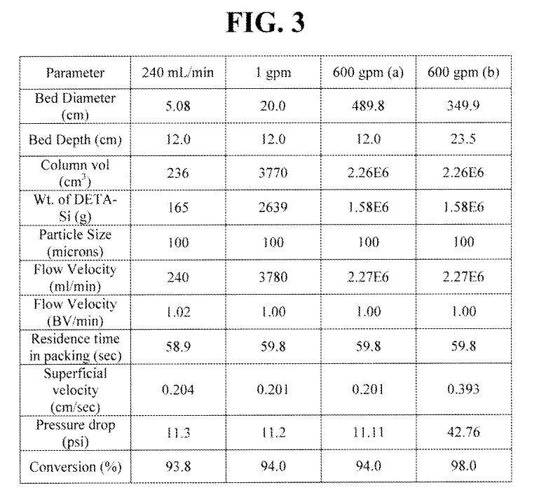

FIG. 3 presents representative design parameters for intermediate scale (240 mL/min), through full-scale (600 gpm) pancake filter reactors. The 1 gpm reactor is ˜5″ long and ˜8″ in diameter, while the 500 gpm reactor is 9.2″ long and 137.8″ in diameter. These designs are based on diffusion-limited adsorption reaction and a residence time of ˜60 seconds.

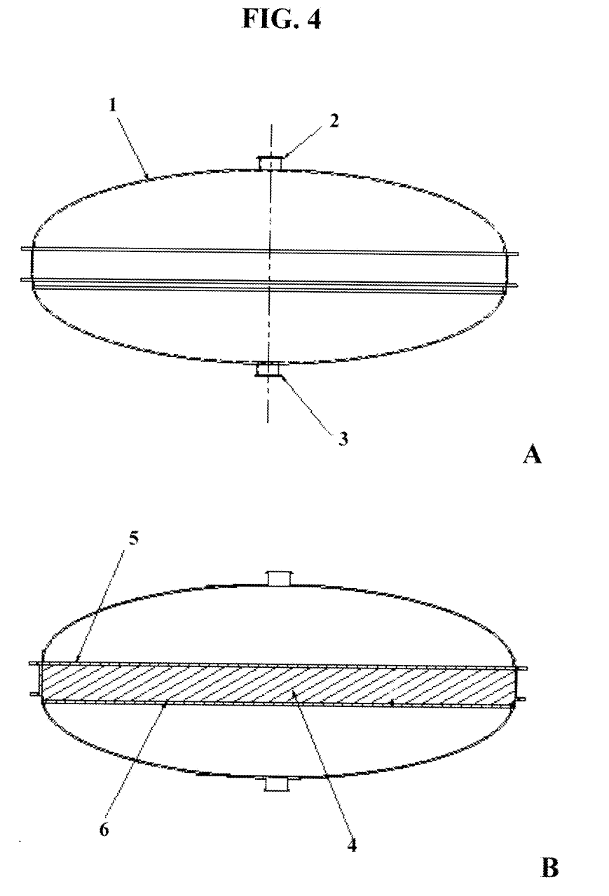

FIG. 4A is an exterior side view of an apparatus comprising a convex, disc-shaped separation chamber 1, fuel inlet 2, and fuel outlet 3 shown. FIG. 4B is a cross-sectional side view of the apparatus showing reactor bed 4 bounded by porous barriers such as perforated steel sheeting upstream 5 and downstream 6 of the solid support upon which chelant is immobilized. The distance between upstream 5 and downstream 6 barriers defines the depth of the reactor bed. In this case reactor bed 4 is planar in shape with constant depth. It is also envisioned that the reactor bed can be non planar to increase surface area within the volume of the separation chamber while maintaining a constant normal distance between 5 and 6 throughout. The performance of reactor beds can deteriorate as the diameter of the reactor bed increases to large industrial-scale systems. Effective fluid distribution in the reactor bed is most preferably achieved using flow diverters known in the art.

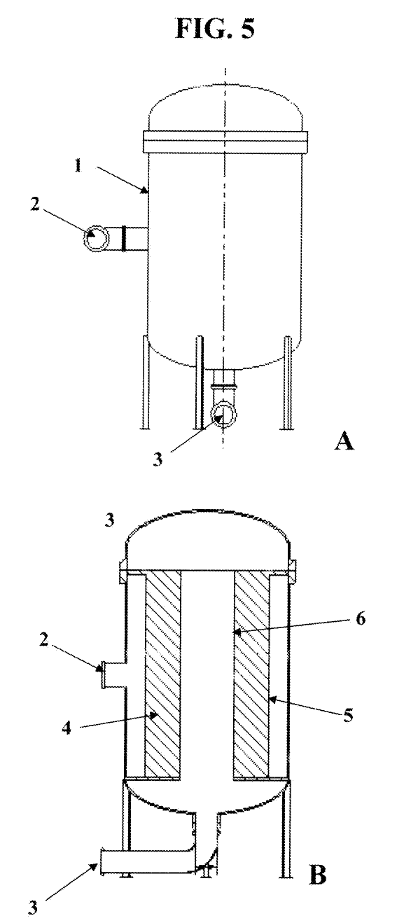

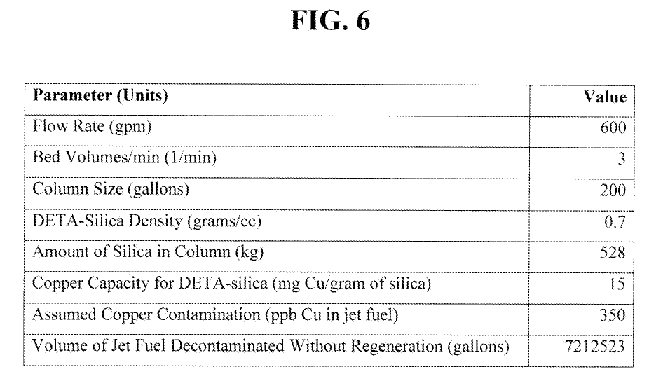

One alternative to the pancake reactor bed configuration is an annular filter. In the annular design, the inner cylindrical gap acts as a flow distribution gap. FIG. 5 A is an exterior side view of an apparatus with an annular design comprising a cylindrical-shaped separation chamber 1, fuel inlet 2, and fuel outlet 3 shown. FIG. 5B is a cross-sectional side view of the apparatus showing reactor bed 4 bounded by porous barriers upstream 5 and downstream 6 of the solid support upon which chelant is immobilized. The distance between upstream 5 and downstream 6 barriers defines the depth of the reactor bed. In this case reactor bed 4 is cylindrical in shape with constant depth. It is also envisioned that the shape of the reactor bed can be changed to increase surface area within the volume of the separation chamber while maintaining a constant normal distance between 5 and 6 throughout. The dome on top of the chamber is optimally removable for filter service, FIG. 6 provides parameters for one embodiment of an apparatus having an annular design.

In addition to the elements shown, the fuel decontamination apparatus may include chemical sensors for dissolved metal concentration at the outlet and additional inlets and outlets upstream and downstream of the rector bed. In the event that sensors detect an unacceptable level of contaminant in the fuel at fuel outlet 4, filter regeneration may be performed, for example by passing a fluid through the reactor bed that displaces reversibly bound metal.

In addition to DETA-silane, chelants useful for removing dissolved copper from fuel may include acyclic and macrocyclic polyamines such as cyclam, TETA, HDDETA, HDTETA, and aminopropyl silica.

Chelants useful for the removal of other metal contaminants are provided in Table 1.

TABLE 1
Chelants functionalized to capture metal ions.

| Chelants | Metal ions |
|---|---|
| 2-Amino-1-cyclopentene-1- | Ag(I), Hg(II), Pd(II) |
| dithiocarboxylic | |
| acid (ACDA) | |
| Bis(2-pyridylalkyl)amine | Cu⁺² |
| Amidinothiourea | Ag⁺, Au⁺³, Pd⁺² |
| 3-(1-thioureido) propyl | Ag⁺, Au⁺³, Pd⁺², Pt⁺² |
| 3-(1-imidazolyl) propyl | Transition Metals |
| 3-(mercapto) propyl | Hg⁺² |
| 2 amino-1,3,4-thiadiazole | Cu complex |
| 2-Mercaptobenzimidazole | Fe⁺³ |
| 2-Mercapto-5-phenylamino-1,3,4- | Pb⁺², Cd⁺², Cu⁺², Hg⁺² |
| thiadiazole | |
| 1,8-Dihydroxyanthraquinone | Fe⁺², Co⁺², Ni⁺² Cu⁺² |

### EXAMPLE

Copper was removed from Jet-A fuel at a flow rate of more than 1 gallon per minute (GPM) using a disc-shaped reactor bed ad shown in FIG. 4. The apparatus comprised a reactor bed 203 mm in diameter and having a depth of 127 mm packed with DETA-modified 70-230 mesh silica beads. Copper-laden Jet-A fuel having a copper concentration of 712 ppb was passed through this column. Samples were drawn from the effluent and tested for copper concentration. Copper concentration of effluent was found to be 65.9 ppb at a flow rate of 4300 mL/min (1.14 GPM) with a pressure drop of 11 psi.

The reactor system selected to illustrate the present invention comprises a packed-bed reactor with DETA-silane supported on silica gel. In addition to packed-bed reactors other types of reactor configurations such as monolith and polylith reactors are also envisioned.

Although there have been described particular embodiments of the present invention, it is not intended that such references be construed as limitations upon the scope of this invention except as set forth in the following claims.

What is claimed is:

1. An apparatus for removing dissolved metal contaminants from a liquid fuel comprising a separation chamber comprising:
a fuel inlet and a fuel outlet separated by a reactor bed wherein:
the reactor bed has a thickness of between about 1″ inches and about 5″ inches,
the reactor bed is packed with a metal chelant immobilized on a solid support,
the solid support comprising beads having a diameter of between about 15 and about 63 micrometers, and
the volume of the reactor bed is between about 33 and about 200 gallons.

2. The apparatus of claim 1 wherein the metal contaminant is selected from the group consisting of copper, zinc, iron, and lead.

3. The apparatus of claim 1 wherein the metal contaminant is copper.

4. The apparatus of claim 3 wherein the chelant comprises DETA.

5. The apparatus of claim 3 wherein the solid support comprises silica beads

6. The apparatus of claim 1 wherein the separation chamber is a tank having a cylindrical shape, the fuel inlet is located in a side wall of the tank, the fuel outlet is located at the top or bottom of the tank, and the reactor bed forms a cylinder inside the tank.

7. The apparatus of claim 1 wherein the separation chamber is a tank in the shape of a convex disc, a fuel inlet at the top or bottom of the tank, a fuel outlet on the opposite side of the tank from the fuel inlet, and the reactor bed forms a planar disc.

8. All apparatus for removing dissolved metal contaminants from a liquid fuel comprising a separation chamber comprising:
a fuel inlet and a fuel outlet separated by a reactor bed wherein:
the reactor bed has a thickness of between about 4″ inches and about 12″ inches,
the reactor bed is packed with a metal chelant immobilized on a solid support, the solid support comprising beads having a diameter of between about 63 and about 200 micrometers, and
the volume of the reactor bed is between about 100 and about 600 gallons.

9. The apparatus of claim 8 wherein the metal contaminant is selected from the group consisting of copper, zinc, iron, and lead.

10. The apparatus of claim 9 wherein the metal contaminant is copper.

11. The apparatus of claim 10 wherein the metal chelant comprises DETA.

12. The apparatus of claim 8 wherein the solid support comprises silica beads

13. The apparatus of claim 8 wherein the separation chamber is a tank having a cylindrical shape, the fuel inlet is located in a side wall of the tank, the fuel outlet is located at the top or bottom of the tank, and the reactor bed forms a cylinder inside the tank.

14. The apparatus of claim 8 wherein the separation chamber is a tank in the shape of a convex disc, a fuel inlet at the top or bottom of the tank, a fuel outlet on the opposite side of the tank from the fuel inlet, and the reactor bed forms a planar disc.

15. A method of removing a dissolved metal contaminant from a liquid fuel comprising:
passing the fuel through a separation chamber comprising:
a fuel inlet and a fuel outlet separated by a reactor bed having a bed volume wherein:
the reactor bed is between about 1 inch and about 12 inches thick and packed with a metal chelant immobilized on a solid support comprising beads having a diameter of between 15 and 200 micrometers;
the flow rate of fuel through the separation chamber is between about one and about three reactor bed volumes per minute; and
the pressure drop between the fuel inlet and the fuel outlet is less than about 50 pounds per square inch; and
the inlet copper concentration is between 100-1000 ppb and outlet concentration is between 10-100 ppb.

16. The method of claim 15 wherein the flow rate of fuel entering through the fuel inlet and exiting through the fuel outlet is between about 100 gallons per minute and about 600 gallons per minute; the solid support comprises beads having a diameter of between 15 and 63 micrometers; the volume of the reactor bed is between about 33 and about 200 gallons, and the thickness of the reactor bed is between 1 and 5 inches.

17. The method of claim 15 wherein the flow rate of fuel entering through the fuel inlet and exiting through the fuel outlet is between about 100 gallons per minute and about 600 gallons per minute; the solid support comprises beads having a diameter of between 63 and 200 micrometers; the volume of the reactor bed is between about 100 and about 600 gallons, and the thickness of the reactor bed is between 4 and 12 inches.

18. The method of claim 15 wherein the metal contaminant is selected from the group consisting of copper, zinc iron, and lead.

19. The method of claim 18 wherein the metal contaminant is copper.

20. The method of claim 19 wherein the metal chelant comprises DETA.
